(19) United States
(12) Patent Application Publication
(10) Pub. No.: US 2023/0377024 A1
(43) Pub. Date: Nov. 23, 2023

(54) DYNAMIC GENERATION OF PERSONALIZED CUSTOMER QUESTIONNAIRE

(71) Applicant: Hungryroot, Inc., New York, NY (US)

(72) Inventors: Antoine Joseph Atallah, Bellevue, WA (US); Alex Weinstein, Bellevue, WA (US); Da Kong, Syosset, NY (US)

(21) Appl. No.: 17/749,873

(22) Filed: May 20, 2022

(51) Int. Cl. G06Q 30/06

(52) U.S. Cl. CPC G06Q 30/0635; G06Q 30/0627

(57) ABSTRACT

Systems and methods to select recipes for a customer. A request for at least one recipe is received for a customer. A plurality of questions are dynamically presented to the customer. This dynamic presentation of questions includes: selecting a next question from a dynamic-question-selection data structure based on a previous question presented to the customer and a previous answer received from the customer; presenting the next question to the customer; and receiving a next answer to the next question from the customer. A plurality of recipe attributes associated with the plurality of questions presented to the customer are identified. A group of initial recipes are selected from a plurality of recipes for the customer based on the plurality of recipe attributes. The at least one recipe for the customer is selected from the group of initial recipes and provided to the customer.

### TECHNICAL FIELD

The present disclosure relates generally to online food distribution services and, more particularly, to generating a dynamic individualized customer questionnaire to identify recipes to be used in predicting and optimizing customer orders.

### BACKGROUND

### Description of the Related Art

The use of online food and grocery ordering has gained in popularity over the past few years. Many of these online services allow customers to select which grocery items they wish to purchase using an online computer interface. After the customer selects and pays for their grocery items, a “runner” collects the items from the shelves such that the customer can simply pick up their order and take it home. Some systems also allow for the items to be sent directly to the customer's home. These systems, however, generally require the customer to know which grocery items they wish to purchase. Some newer systems have added the option of a customer selecting a particular recipe. The specific items and their portions for that particular recipe are then sent to the customer. Upon arrival, the customer can prepare the recipe using the items provided. Unfortunately, many of these online food-purchasing systems are limited by the customer's preferences and provide little flexibility in understanding how different customers may prefer different recipes. It is with respect to these and other considerations that the embodiments described herein have been made.

### BRIEF SUMMARY

Briefly described, embodiments are directed toward systems and methods of selecting recipes for a customer. A plurality of questions are dynamically presented to the customer. This dynamic presentation of questions may include: selecting a next question from a dynamic-question-selection data structure based on a previous question presented to the customer and a previous answer received from the customer; presenting the next question to the customer; and receiving a next answer to the next question from the customer. A plurality of recipe attributes associated with the plurality of questions presented to the customer are identified and a group of initial recipes are selected from a plurality of recipes for the customer based on the plurality of recipe attributes. The at least one recipe for the customer is selected from the group of initial recipes and provided to the customer.

The dynamic presentation of questions may select the next question from the dynamic-question-selection data structure by determining if the next question is answered by the preferences of the customer; and in response to the preferences of the customer answering the next question, utilizing the preferences to answer the next question without presenting the next question to the customer. In some embodiments, the dynamic-question-selection data structure is generated by: presenting a plurality of groups of questions to a plurality of training users; receiving answers from the plurality of training users; presenting a plurality of test recipes to the plurality of training users based on questions and answer received from the plurality of training users; receiving feedback from the plurality of training users; and modifying the plurality of groups of questions based on the feedback.

In various embodiments, selecting the at least one recipe from the group of initial recipes may include: predicting a plurality of recipes from the group of initial recipes for the order based on preferences of the customer and an order history of the customer; generating a plurality of sets of recipes from the plurality of predicted recipes based on at least one first constraint that constraints that cannot be violated by a recipe or set of recipes for the customer; optimizing the plurality of sets of recipes based on at least one second constraint that that expresses a tradeoff value associated with a recipe or set of recipes for the customer; and selecting the at least one recipe for the order based on the optimized plurality of sets of recipes. Filling the request may then be initiated for the customer with items associated with the at least one recipe.

In some embodiments, feedback may be received from the customer, and the dynamic-question-selection data structure may be updated based on the feedback. In some embodiments, a new plurality of questions is dynamically presented to the customer based on the feedback, which may include: selecting a new next question from the dynamic-question-selection data structure based on the feedback and a new previous question presented to the customer and a new previous answer received from the customer; presenting, the new next question to the customer; and receiving a new next answer to the new next question from the customer. In various embodiments, a new plurality of recipe attributes associated with the new plurality of questions presented to the customer may be identified. In this way, a new group of initial recipes may be selected and provided to the customer based on the new plurality of recipe attributes.

Embodiments described herein can improve the operation of the item delivery computing systems, reduce errors in item deliveries, improve customer satisfaction, reduce the amount of food waste in the customers' home and at the fulfillment warehouse, and even improve the operation of the various computing components of the system. For example, by dynamically selecting questions for the customer based on previous questions and answers can result in fewer computing resources being utilized to determine which recipes the customer may enjoy.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1 illustrates a context diagram of an environment for selecting, predicting, and optimizing customer recipe orders in accordance with embodiments described herein;

FIG. 2 is a context diagram of non-limiting embodiments of systems for obtaining data utilized in selecting, predicting, and optimizing of customer recipe orders in accordance with embodiments described herein;

FIG. 3 illustrates a logical flow diagram showing one embodiment of a process for predicting and optimizing a customer recipe order in accordance with embodiments described herein;

FIG. 4 illustrates a logical flow diagram showing one embodiment of a process for predicting recipes for a customer in accordance with embodiments described herein;

FIG. 5 illustrates a logical flow diagram showing one embodiment of a process for optimizing and scoring predicted recipes for a customer in accordance with embodiments described herein;

FIG. 6 illustrates a logical flow diagram showing one embodiment of an overview process for generating a dynamic questionnaire for a customer and modifying future questions based on customer feedback in accordance with embodiments described herein;

FIG. 7 illustrates a logical flow diagram showing one embodiment of a process for selecting and presenting questions to a customer and selecting recipes based on those questions in accordance with embodiments described herein;

FIG. 8 illustrates a logical flow diagram showing one embodiment of a process for processing customer feedback in accordance with embodiments described herein;

FIG. 9 illustrates a logical flow diagram showing one embodiment of a process for utilizing customer feedback to modify future questions in accordance with embodiments described herein;

FIGS. 10-11 illustrate use case examples of data structures for dynamically selecting questions for customers in accordance with embodiments described herein;

FIG. 12 illustrates a use case example of a data structure mapping recipes and attributes in accordance with embodiments described herein; and

FIG. 13 shows a system diagram that describes various implementations of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

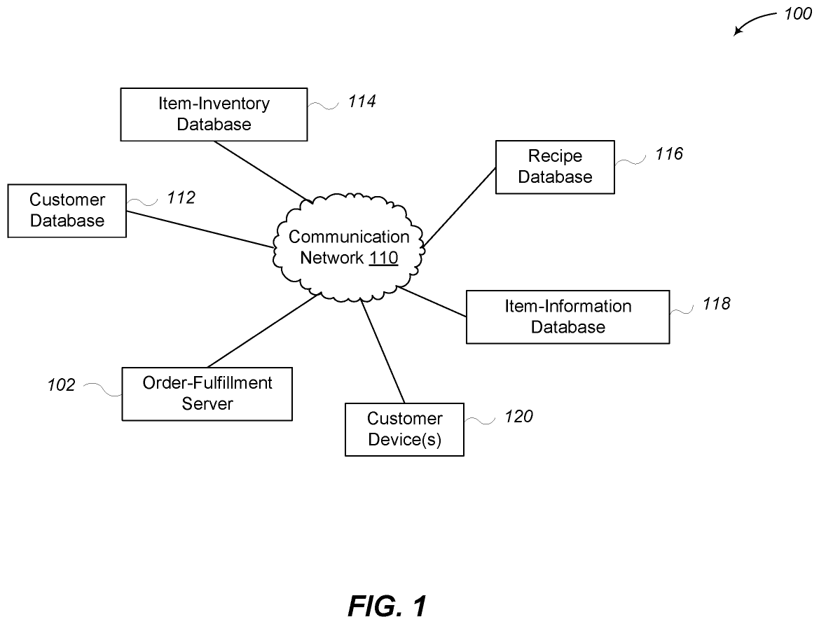

FIG. 1 illustrates a context diagram of an environment 100 for selecting, predicting, and optimizing customer recipe orders in accordance with embodiments described herein. In this example, environment 100 includes an order-fulfillment server 102, a customer database 112, an item-inventory database 114, a recipe database 116, an item-information database 118, and a customer devices 120. These computing devices can communicate with one another via communication network 110. Communication network 110 includes one or more wired or wireless networks in which data or communication messages are transmitted between various computing devices.

The order-fulfillment server 102 is a computing device that selects which questions to independently select and present to different customers of customer devices 120 based on the customers' answers to previous questions. For each customer, the order-fulfillment server 102 can utilize the questions and the customer's answers to select an initial group of recipes for that customer. From this group of initial recipes, the order-fulfillment server 102 can predict which recipes the customer may enjoy and optimize those recipes to select a set of optimized recipes to provide to the customer.

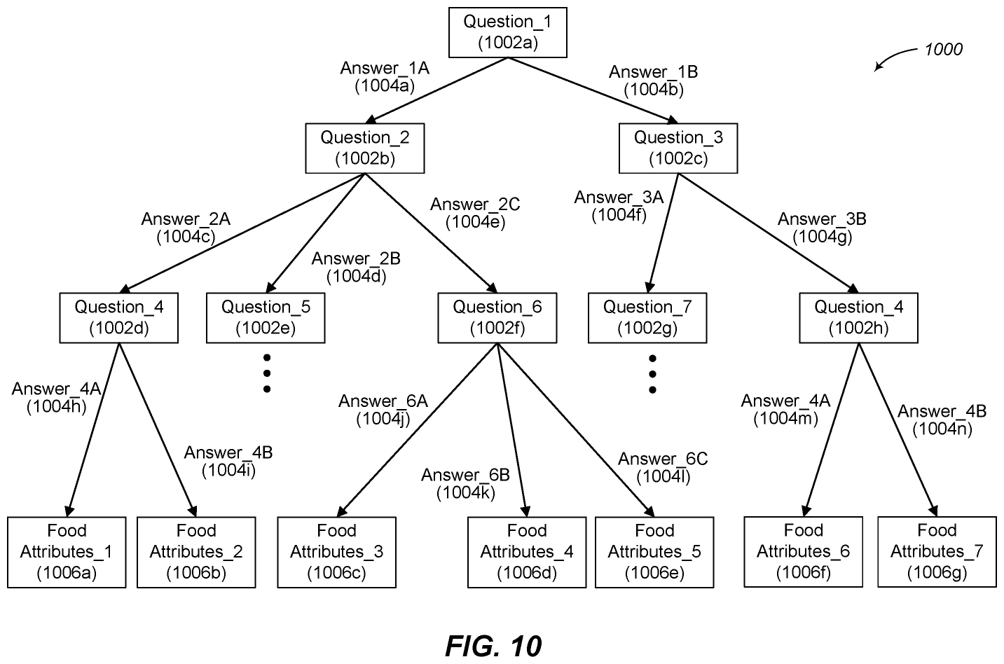

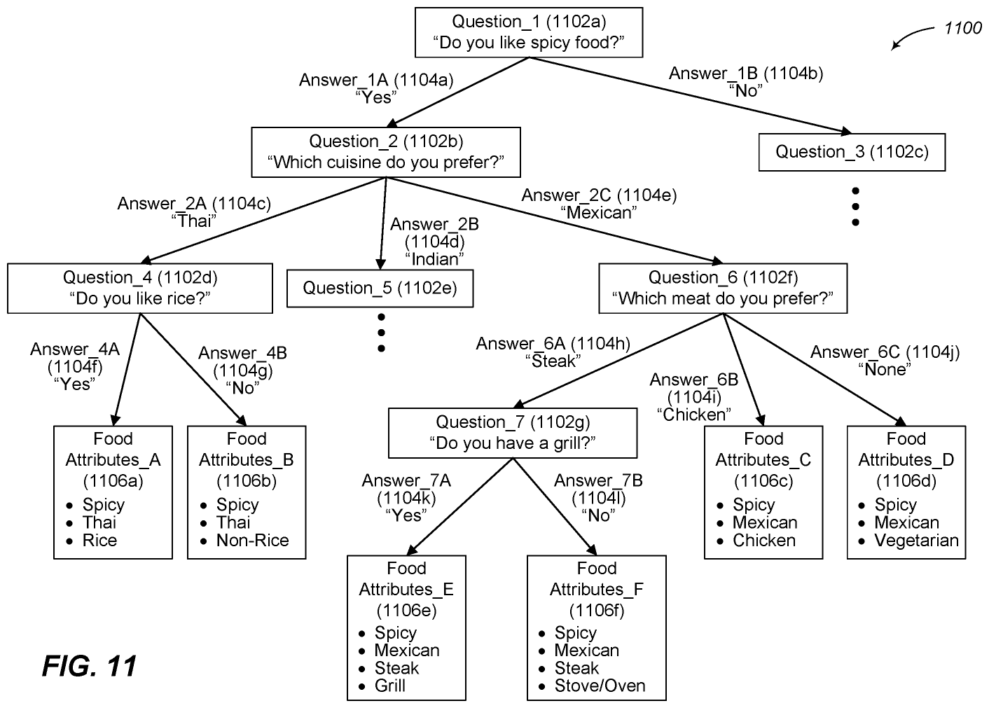

To select and present questions to the customer, the order-fulfillment server 102 trains or generates a dynamic-question-selection data structure. This data structure may be in the form of a tree structure, such as illustrated in FIGS. 10 and 11, or it may be a spreadsheet or other data structure that groups questions according to the training users' answers. In some embodiments, this data structure is generated by employing one or more machine learning techniques that systematically asks a plurality of training users to answer different sub-groups of known questions having known answers. Based on those questions and answers, the system selects initial recipes for each sub-group. Each question and answer is mapped to or associated with one or more recipe attributes. Similarly, each of the plurality of possible recipes is mapped to or associated with one or more recipe attributes. The attributes associated with each question and answer in the sub-group of questions and answers is then used to select the initial recipes. Positive and negative feedback from training users indicate the success or failure of each sub-group of questions. The feedback can be used to update or modify the dynamic-question-selection data structure by eliminating one or more sub-groups of questions, merging two or more sub-groups of questions, adding questions, or reinforcing one or more sub-groups of questions. As described herein, customer feedback is also used to update and modify the dynamic-question-selection data structure.

Although the order-fulfillment server 102 is described as generating this dynamic-question-selection data structure, embodiments are not so limited. Rather, the dynamic-question-selection data structure may be generated by the order-fulfillment server 102, the recipe database 116, or some other computing device or system (not illustrated), or some combination thereof.

After the dynamic-question-selection data structure is generated, the order-fulfillment server 102 receives a customer registration request from a customer device 120. During the registration process, the order-fulfillment server 102 presents a question to the customer of the customer device 120 and receives an answer. From this answer, the order-fulfillment server 102 selects and presents a next question to the customer based on the dynamic-question-selection data structure, and the order-fulfillment server 102 receives an answer to that next question. The order-fulfillment server 102 continues to select and present questions to the customer using the dynamic-question-selection data structure. When the question selection process is completed, the selected questions and answers are utilized to select a plurality of initial recipes for the customer.

The order-fulfillment server 102 can then receive an order request from the customer device 120. The order-fulfillment server 102 utilizes the plurality of initial recipes for that customer, customer preferences, and customer history information to predict a plurality of recipes for the customer. The order-fulfillment server 102 can then use hard constraints and soft constraints to optimize and score the predicted recipes into a plurality of sets of recipes. The order-fulfillment server 102 selects one of these sets of recipes to provide to the user. The order-fulfillment server 102 can then initiate delivery of the items and recipes associated with the selected set of recipes to the customer to fulfill the order.

Although the order-fulfillment server 102 is described as selecting and presenting questions to the customer during a registration process, embodiments are not so limited. In some embodiments, the order-fulfillment server 102 selects and presents questions to the customer in response to each separate order request, in response to random order requests, in response to pre-set intervals of order requests, in response to pre-selected order requests, or the like. In this way, the order-fulfillment server 102 can select a separate plurality of initial recipes for the customer for separate order requests based on the questions provided to the customer and the answers received from the customer. Because the customer may not appreciate or may not like one or more of the optimized recipes that they received, as described herein, presenting new questions to the customer may result in a different group of initial recipes from which to predict and optimize for the customer for a next order. As discussed in more detail below, feedback provided by the customer may be used to change the customer's previous answers, which can then be used to select new questions to present to the customer.

The customer devices 120 are computing devices that can communicate with the order-fulfillment server 102 to provide customer preferences, receive and present questions to the customer, receive customer input indicting answers to those questions, request a recipe set and corresponding items be delivered to the customer, modify one or more items or recipes associated with a recipe set that is selected for delivery to the customer, etc. Examples of customer devices 120 may include personal computers, laptop computers, smartphones, tablet computers, etc.

The customer database 112 is a computing device that is configured to store customer information for a plurality of customers. The customer information may include, but is not limited to, customer preferences, customer order history, customer customization history, list of items previously provided to the customer, current customer inventory (e.g., items or ingredients already owned by the customer), etc. In some embodiments, the customer information may also store a history of the questions selected and presented to the customers and the answers received from the customer. The customer database 112 is further configured to communicate with the order-fulfillment server 102 via the communication network 110 to provide various customer information to the order-fulfillment server 102 to enable the order-fulfillment server 102 to select initial recipes, and to predict and optimize the initial recipes for customers, as described herein.

The recipe database 116 is a computing device that is configured to store a plurality of recipes. The recipe database 116 is configured to communicate with the order-fulfillment server 102 via the communication network 110 to provide lists of recipes and their items to the order-fulfillment server 102 for the order-fulfillment server 102 to predict and optimize recipes for customers, as described herein.

The item-inventory database 114 is a computing device configured to store inventory information regarding a plurality of items that are associated with at least one recipe stored by the recipe database 116 and can be delivered to a customer. The item-inventory database 114 is further configured to communicate with the order-fulfillment server 102 via the communication network 110 to provide item-inventory information to the order-fulfillment server 102 for the order-fulfillment server 102 to optimize recipes for customers, as described herein.

The item-information database 118 is a computing device that is configured to store information regarding the plurality of items that are associated with at least one recipe stored by the recipe database 116. This item information may include, but is not limited to, dietary information, specific ingredients, cost or price, volume metrics, etc. The item-information database 118 is further configured to communicate with the order-fulfillment server 102 via the communication network 110 to provide item information to the order-fulfillment server 102 for the order-fulfillment server 102 to optimize recipes for customers, as described herein.

Although the order-fulfillment server 102, the customer database 112, the item-inventory database 114, the recipe database 116, and the item-information database 118 are illustrated as separate computing devices, embodiments are not so limited. Rather one or more computing devices or systems may be utilized to perform the functionality of the order-fulfillment server 102, the customer database 112, the item-inventory database 114, the recipe database 116, and the item-information database 118. Accordingly, in some embodiments, the order-fulfillment server 102 may store or manage the customer database 112, the item-inventory database 114, the recipe database 116, or the item-information database 118, or some combination thereof.

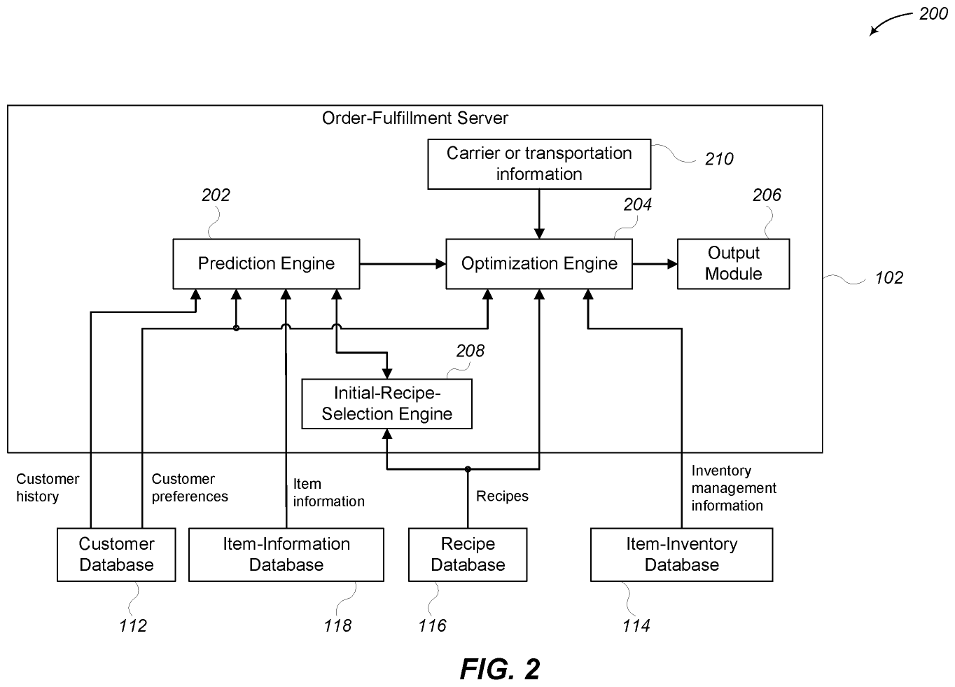

FIG. 2 is a context diagram of non-limiting embodiments of systems for obtaining data utilized in selecting, predicting, and optimizing of customer recipe orders in accordance with embodiments described herein. Example 200 includes an order-fulfillment server 102, a customer database 112, an item-inventory database 114, a recipe database 116, and an item-information database 118, which are similar to what is discussed above in conjunction with FIG. 1.

The order-fulfillment server 102 includes a prediction engine 202, an optimization engine 204, an output module 206, and an initial-recipe-selection engine 208. In some embodiments, the order-fulfillment server 102 may also store carrier or transportation information 210.

The initial-recipe-selection engine 208 selects one or a plurality of initial recipes to be used by the prediction engine 202 and the optimization engine 204 to generate a plurality of optimized recipe sets from which the output module 206 selects a set of recipes for the customer. As discussed herein, the initial-recipe-selection engine 208 may generate the initial recipes for the customer during a registration process or when an order request is received for the customer or at other times.

The initial-recipe-selection engine 208 utilizes a dynamic-question-selection data structure, as described herein, to select questions for the customer to answer. The particular questions that are selected are based on the answers provided by the customer to previous questions and the dynamic-question-selection data structure. In various embodiments, the initial-recipe-selection engine 208 includes or communicates with an input-output interface (not illustrated) to present questions to a customer device and to receive answers from the customer device. Moreover, the initial-recipe-selection engine 208 may include or communicates with a database (not illustrated) that maintains the dynamic-question-selection data structure. In some embodiments, the initial-recipe-selection engine 208 may also be configured to generate or modify the dynamic-question-selection data structure, as described herein.

After the initial-recipe-selection engine 208 has provided questions and received answers, the initial-recipe-selection engine 208 identifies the collective group of recipe attributes that are mapped to the group of selected questions and customer answers. The initial-recipe-selection engine 208 communicates with the recipe database 116 to select initial recipes that include the recipe attributes mapped to the selected questions and customer answers. In some embodiments, the initial recipes may match the mapped attributes. In other embodiments, one or more of the initial recipes may include additional recipe attributes beyond the recipe attributes mapped to the selected questions and customer answers.

The prediction engine 202 receives an order request from a customer. The prediction engine 202 obtains a variety of customer-related information from the customer database 112. For example, the prediction engine 202 collects customer history information, customer preferences, and the customer's current inventory from the customer database 112. The prediction engine 202 also obtains a list of the initial recipes for the customer from the initial-recipe-selection engine 208. In some embodiments, the prediction engine 202 may also access (not illustrated) the recipe database 116 to obtain additional recipes or to obtain other recipe information, such as to obtain a list of items for each initial recipe identified by the initial-recipe-selection engine 208. The prediction engine 202 can use the list of initial recipes to collect item information for the recipes from the item-information database 118. This item information may include dietary information or specific ingredients for each recipe. In some embodiments, the item information may be included with the list of initial recipes received from the initial-recipe-selection engine 208. The prediction engine 202 utilizes the recipes and the item information, along with the customer history and preferences, as input to one or more artificial intelligence learning models to predict which recipes the customer may like. The prediction engine 202 provides a list of predicted recipes to the optimization engine 204.

The optimization engine 204 queries the recipe database 116 to identify a list of items for each predicted recipe. In some embodiments, the optimization engine 204 may obtain the list of items for each predicted recipe from the initial-recipe-selection engine 208. The optimization engine 204 obtains additional item information for the listed from the item-information database 118. The optimization engine 204 can also obtain inventory management information for the listed items from the item-inventory database 114. The optimization engine 204 utilizes the predicted recipes, the additional item information, and the inventory information to optimize the predicted recipes, as described herein. In various embodiments, the optimization engine 204 also utilizes customer information (e.g., as obtained from customer database 112 to optimize the predicted recipes, which allows the system to not only select recipes that the customer may like, but also to select recipes that utilize items already owned by the customer. In some embodiments, the optimization engine 204 generates a plurality of sets of recipes, while evaluating each recipe set and individual recipe to one or more hard constraints. The optimization engine 204 discards those recipe sets that violate at least one hard constraint. The optimization engine 204 can then score the remaining predicted recipes using a plurality of soft constraints, as discussed herein.

In some embodiments, the optimization engine 204 can optimize recipe sets across a plurality of customers. For example, the prediction engine 202 can separately generate a plurality of predicted recipes for each of a plurality of customers. The optimization engine 204 separately evaluate each plurality of predicted recipes with respect to hard constraints and soft constraints. The optimization engine 204 can then evaluate one or more additional soft constraints that are evaluated among multiple pluralities of predicted recipes. One example of such a soft constraint may be inventory status relative to customer preferences. For example, if a first customer “likes” chicken and a second customer “loves” chicken, but the chicken inventory is low, then the recipe set scores for the first customer that include chicken may be reduced, and the recipe set scores for the second customer that include chicken may be increased.

In some embodiments, the optimization engine 204 can also use the carrier or transportation information 210 to optimize the predicted recipes. For example, if a carrier is delayed or if there are shipping issues regarding one or more items, then the optimization engine 204 can reduce the score of those recipe sets that include items that may experience shipping, transportation, or inventory issues. The optimization engine 204 provides a plurality of optimized recipe sets to the output module 206.

The output module 206 selects a set of recipes from the plurality of optimized recipe sets. In at least one embodiment, the output module 206 selects a highest scoring recipe set. The output module 206 can then initiate fulfillment of the customer's order with the items associated with the selected recipe set.

In some embodiments, the output module 206 may optionally present one or more of the plurality of optimized recipe sets to the customer prior to the fulfillment of the customer's order. In various embodiments, the output module 206 may display a selected number of highest scoring recipe sets to the customer, such as via customer device 120. In other embodiments, the output module 206 may identify two or more recipes that share one or more characteristics (e.g., cost, packaging size, cuisine, ingredient, etc.) and present those recipes to the customer. In at least one such embodiment, the system may enable the customer to select between one or more of these recipes to be included in the order. For example, the output module 206 may display a list of two pasta recipes, such that the customer can select one to include in the order.

Although embodiments are described herein as utilizing the prediction engine 202 and the optimization engine 204 to predict and optimize the initial recipes selected by the initial-recipe-selection engine 208, embodiments are not so limited. In other embodiments, the initial-recipe-selection engine 208 may provide (not illustrated) the initial recipes the output module 206 without additional processing by the prediction engine 202 and the optimization engine 204.

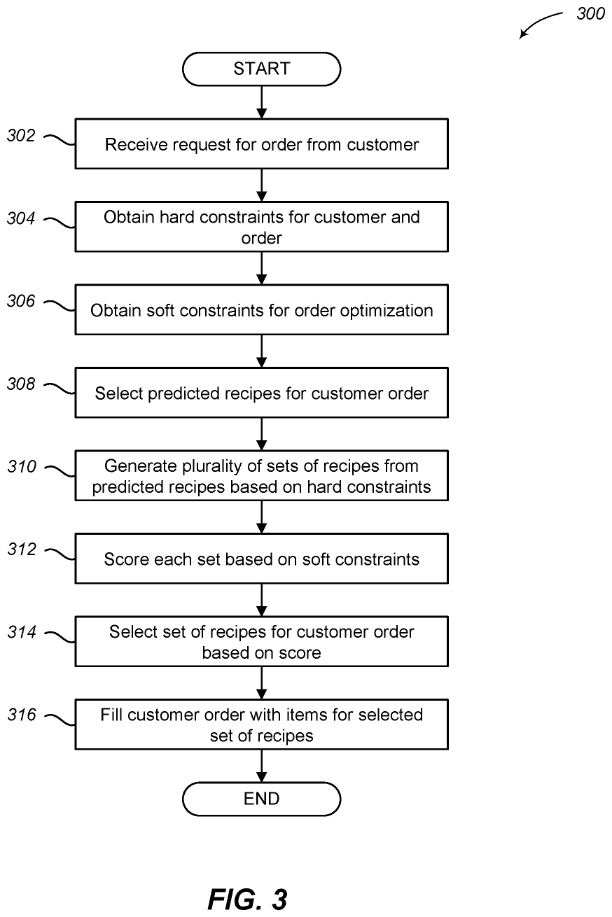

The operation of certain aspects will now be described with respect to FIGS. 3-9. In at least one of various embodiments, processes 300 to 900 described in conjunction with FIGS. 3-9 may be implemented by or executed via circuitry or on one or more computing devices, such as order-fulfillment server 102 in FIG. 1.

FIG. 3 illustrates a logical flow diagram showing one embodiment of a process 300 for predicting and optimizing a customer recipe order in accordance with embodiments described herein.

Process 300 begins, after a start block, at block 302, where a request for an order is received from a customer. In various embodiments, the customer may setup or schedule orders for deliveries on specific days, at specific time intervals, or for specific occasions. As described herein, an order is a request for a set of recipes, and the items needed to make those recipes, to be delivered to the customer. Items are objects provided with the recipes for the customer to make the recipes. Items may include the various ingredients or food products needed to make the recipes. In some embodiments, items may also include cooking utensils, measurement tools, or other non-food objects needed to make the recipes.

Process 300 proceeds to block 304, where one or more hard constraints are obtained for the customer and the order. The hard constraints define at least one parameter that cannot be violated by a recipe or set of recipes for the customer. In various embodiments, the hard constraints may be in two groups, a first group of one or more hard constraints that are evaluated at the recipe-set level and a second group of one or more hard constraints that are evaluated at the recipe level. Accordingly, a set of a plurality of recipes selected for the customer may not violate a hard constraint from the first group of hard constraints and an individual recipe in a recipe set may not violate a hard constraint from the second group of hard constraints. Any violations of a hard constraint will result in the corresponding set of recipes to be discarded and not provided to the customer.

Examples, of hard constraints may include, but are not limited to:
A recipe set cannot contain a recipe that includes an item that is an allergen to the customer (e.g., a recipe cannot contain an item that includes peanuts as an ingredient).
A recipe set cannot contain a recipe that includes an item that is restricted by the customer (e.g., no chicken as an item). A customer may identify an item as being restricted because the customer does not like the item.
A recipe set cannot contain a recipe or item prohibited by the customer (e.g., a recipe cannot include dairy products). A customer may identify a recipe or item as being prohibited because of a dietary restriction (e.g., the customer is allergic to an ingredient in the item or recipe).
A recipe set cannot have a cost that exceeds a customer-selected or company-defined or administrator-selected maximum cost.
A recipe set cannot have a total packaging volume exceeding a maximum volume (e.g., the items for a set of recipes cannot exceed a selected shipping-box volume).
A recipe set cannot have a total number of items that exceeds a maximum number of items.
A recipe set cannot include an item have more servings than a select threshold.
   These examples of hard constraints are for illustrative purposes and are not intended to be limiting. In various embodiments, the hard constraints may be input or modified by an administrator.

Process 300 continues to block 306, where one or more soft constraints are obtained for order optimization. The soft constraints define at least one parameter that expresses a tradeoff value associated with a recipe or set of recipes for the customer. As discussed in more detail herein, the soft constraints may be utilized to score a recipe or set of recipes. Accordingly, evaluation of one or more soft constraints may result in an increase or a reduction of a recipe set score.

Examples of soft constraints may include, but are not limited to:
Item inventory relative to a minimum or maximum inventory:
   An item that is out of stock or under an inventory minimum (e.g., recipe set score be decreased if an item of a recipe in that recipe set is out of stock—so as to discourage use of that item in a recipe set).
   An item that is in stock or over an inventory maximum (e.g., a recipe set score may be increased if the inventory of an item of a recipe in that recipe set exceeds an inventor maximum—so as to encourage use of that item in a recipe set to reduce the inventory of that item).
A recipe set having a cost that exceeds a minimum or maximum customer-selected cost (e.g., a recipe set score may be decreased a first amount if the recipe set has an aggregated item price that exceeds the customer-selected maximum cost, and the recipe set score may be decreased a second, smaller amount if the recipe set has an aggregated item price that exceeds the customer-selected minimum cost).
A recipe set that exceeds a maximum or minimum number of meals for the customer (e.g., a recipe set score may be decreased a first amount if the recipe set includes a number of meals less than a customer-selected number of meals, and the recipe set score may be decreased a second, smaller amount if the recipe set includes a number of meals over the customer-selected number of meals).
A recipe set that has an incorrect number of servings for different customer-selected mealtimes (e.g., a recipe set score may be decreased one or more amounts based on a type of serving missing for different mealtimes).
A recipe set that includes multiple recipes having at least one overlapping item (e.g., a recipe set score may be decreased for each duplicate item among recipes in the recipe set).
A recipe set having a recipe that was previously provided to the customer (e.g., a recipe set score may be decreased a first amount for a repeated recipe within a first threshold amount of time, or the recipe set score may be decreased a second, higher amount for a repeat of two or more recipes from a same set within a second, longer threshold amount of time).
A recipe set matching at least one customer preference (e.g., a recipe set score may be increased a first amount if an item or recipe in the recipe set matches a first customer preference, and the recipe score may be increased a second, higher amount if an item or recipe in the recipe set matches a second customer preference).
A recipe set failing to match at least one customer preference (e.g., a recipe set score may be decreased a first amount if an item or recipe in the recipe set fails to match a first customer preference, and the recipe score may be decreased a second, higher amount if an item or recipe in the recipe set fails to match a second customer preference).
A recipe set score relative to aggregated customer feedback.
   Customers “liking” or “disliking” a recipe in the recipe set.
   Customers “liking” or “disliking” an item or ingredient associated with a recipe in the recipe set.
A recipe set containing items already owned by the customer.
   These examples of soft constraints are for illustrative purposes and are not intended to be limiting. In various embodiments, the soft constraints may be input or modified by an administrator.

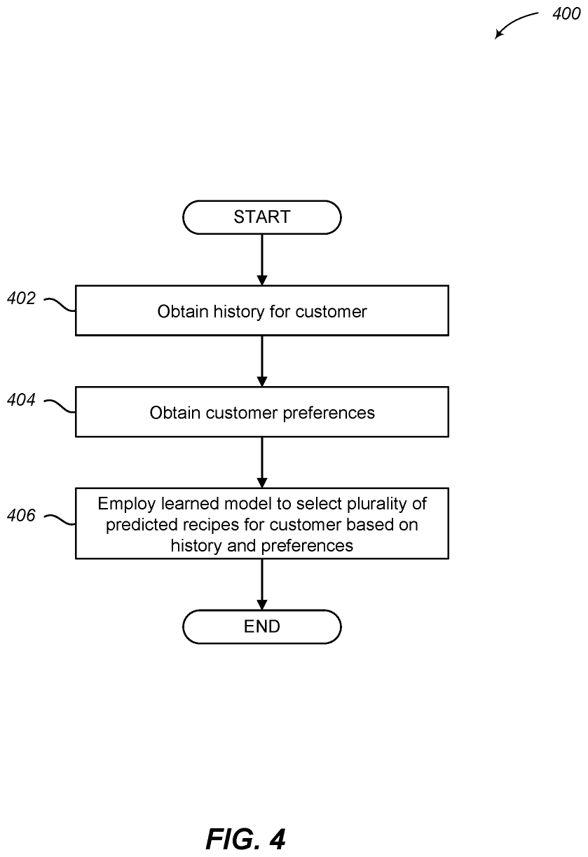

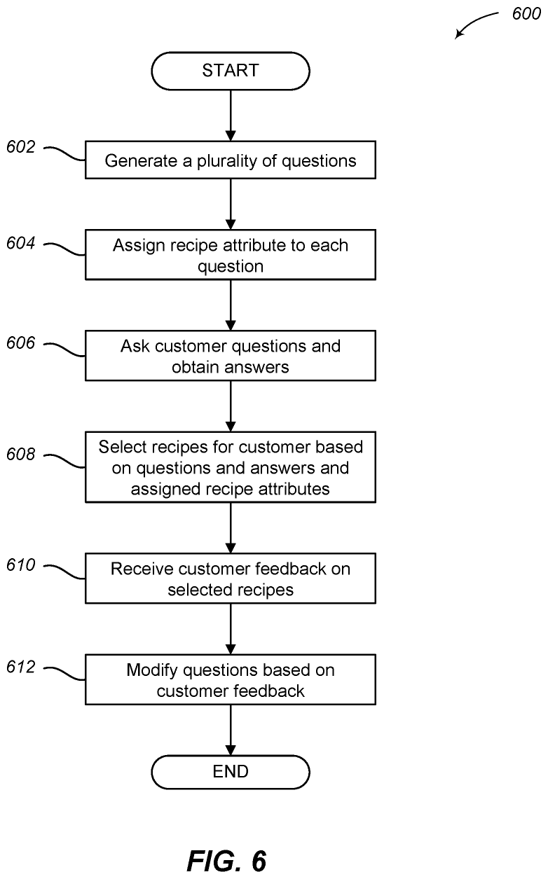

Process 300 proceeds next to block 308, where a plurality of predicted recipes are selected for the customer order, which is described in more detail below in conjunction with FIG. 4. Briefly, however, customer preferences and the customer's order history are utilized to predict which recipes the customer should enjoy. In various embodiments, the predicted recipes are selected from a group of initial recipes selected for the customer. The group of initial recipes may be selected for the customer using a dynamic-question-selection data structure, which is described in more detail below in conjunction with FIG. 6.

Process 300 continues at blocks 310 and 312, where the plurality of predicted recipes are optimized for the customer's order.

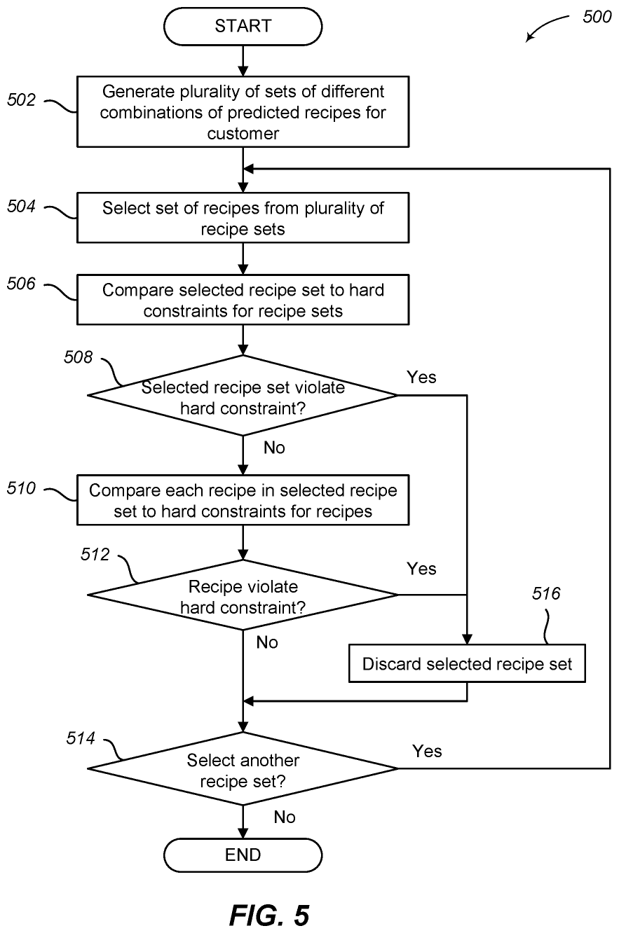

First, at block 310, a plurality of sets of recipes are generated from the plurality of predicted recipes, which is described in more detail below in conjunction with FIG. 5. Briefly, however, each recipe and set of recipes is compared to the hard constraints to determine which recipe sets satisfy the hard constraints.

Second, at block 312, each recipe set is scored based on the soft constraints. In some embodiments, an inventory of items for each item associated with a recipe in the generated recipe sets is obtained from an inventory database, such as item-inventory database 114 in FIG. 1. Similarly, the customer's preferences may be obtained from a customer database, such as customer database 112 in FIG. 1.

Each recipe set is compared to the soft constraints, and a recipe set score is modified based on how well that recipe set follows the soft constraints. For example, if the cost of a recipe set exceeds the customer-selected maximum cost, then the score for that recipe set is reduced an amount determined by that soft constraint. As another example, the score for a recipe set may be modified based on whether the customer, or other customers, have “liked” or “disliked” specific recipes or items (e.g., specific ingredients or specific instructions or specific utensils needed to execute the recipe) associated with the recipe set. As another example, the customer may provide information regarding currently owned items. The score of a recipe set may be increased if the customer already owns an item associated with the recipe set.

Process 300 proceeds next to block 314, where a set of recipes is selected for the customer order based on the scores generated at block 312. In various embodiments, a highest scoring recipe set is selected for the customer order. In other embodiments, a recipe set is randomly selected from those recipe sets having a score above a selected threshold. This threshold may be selected or set by an administrator or by the customer. For example, a customer may lower the score threshold to introduce more variety into the recipe sets being selected for the customer. Conversely, the customer may raise the score threshold to reduce variety and cause the system to select recipe sets that more closely align with the customer's preferences or history.

Process 300 continues to block 316, where the customer order is filled with items for the selected set of recipes. In some embodiments, automated item selection robotic mechanisms may be controlled to select the items from one or more shelves in an item warehouse and fill a delivery box with those items. In other embodiments, a list of items for the selected set of recipes is output to a warehouse worker to enable that worker to collect the items and fill the delivery box.

After block 316, process 300 may terminate or otherwise return to a calling process to perform other actions. For example, in some embodiments, process 300 may loop (not illustrated) to block 302 to receive another order request for the same customer or for a different customer.

FIG. 4 illustrates a logical flow diagram showing one embodiment of a process 400 for predicting recipes for a customer in accordance with embodiments described herein. As mentioned above, process 400 may be performed at block 308 in FIG. 3.

Process 400 begins, after a start block, at block 402, where a history for the customer is obtained. In various embodiments, the customer's history includes previous recipes selected for the customer, ratings provided by the customer on previous recipes, ratings provided by the customer on previous recipe combinations in a set of recipes, previous alterations or customizations provided by the customer, etc. For example, the customer history may indicate that each previously selected recipe containing beef is modified by the customer to exchange the beef for chicken. As another example, the customer history may indicate that the customer gives high ratings to recipe sets that include Italian recipes with French recipes in the same set. Other customer history information can also be obtained.

Process 400 proceeds to block 404, where one or more customer preferences are obtained. In various embodiments, these customer preferences are selected by the customer when the customer signs up to have recipe sets and corresponding items delivered to the customer. In other embodiments, the customer preferences are automatically generated based on questions answered by the customer. In yet other embodiments, the customer preferences may be inferred from the customer's actions or interactions with the system. The customer preferences may include, but are not limited to customer dietary preferences, customer dietary restrictions, customer configurations (e.g., number of servings per recipe, preferred cuisines, etc.),

Process 400 continues at block 406, where a learned model is employed to select a plurality of predicted recipes for the customer based on the customer history and the customer preferences.

In various embodiments, the model is trained using one or more artificial intelligence or machine learning techniques. The training data may include item attributes, recipe attributes (e.g., items or ingredients, item quantities, number of steps, preparation time, cook time, etc.), customer dietary preferences, customer dietary restrictions, customer configurations, and past customer customizations of items from a plurality of customers for a plurality of previously selected recipes for those customers. The item attributes may include information describing various aspects of an item, which may include a list of ingredients, dietary information (e.g., number of calories, amount of sugar, amount of fat, etc.), allergens, dietary restrictions (e.g., vegan, dairy free, gluten free, etc.), or other information regarding the item. The customer dietary preferences may include a customer's food likes and dislikes, such as the types of cuisines the customers like or dislike, specific food items that the customer would prefer or would prefer to not have, etc. The customer dietary restrictions may include different types of diets, food fads, common food allergies (e.g., nut allergies, dairy allergies, or oral allergy syndrome), etc. of a customer. The customer configurations may include selections and preferences of a customer, such as the number of meals, types of meals (e.g., dinner, lunch, breakfast, snack, or dessert), requested numbers of recipes in a set of recipes, etc. The past customer customizations may include information indicating which recipe or item alterations, exchanges, or changes a customer has made to specific recipes. In some embodiments, the training data may also include customer feedback, such as how the customer rated or liked items or recipes that they have previous received. In other embodiments, the training data may include customer attributes that are not directed related to recipes or items or information inferred about a customer, such as demographics, geographic location, income and budget, etc.

In some embodiments, the model may be trained for specific geographic area, for specific dietary needs, for specific customer demographics, or other grouping criteria. In this way, the predicted recipes may be more closely tailored to the customer.

After block 406, process 400 may terminate or otherwise return to a calling process to perform other embodiments. For example, process 400 may return the predicted recipes to process 300 in FIG. 3 for further processing.

FIG. 5 illustrates a logical flow diagram showing one embodiment of a process 500 for scoring predicting recipes for a customer in accordance with embodiments described herein. As mentioned above, process 500 may be performed at block 310 in FIG. 3.

Process 500 begins, after a start block, at block 502, where a plurality of sets of different combinations of predicted recipes is generated. The predicted recipes may be generated as discussed above, such as in conjunction with FIG. 4. A set of recipes is a set that includes one or more recipes. In various embodiments, each possible combination of predicted recipes is generated.

Process 500 proceeds to block 504, where a set of recipes is selected from the plurality of sets of recipes. Each recipe set may be selected in a logical order such that each recipe set is compared to the hard constraints.

Process 500 continues at block 506, where the selected recipe set is compared to the hard constraints for recipe sets. As discussed herein, the hard constraints may be in two groups, a first group of one or more hard constraints that are evaluated at the recipe-set level and a second group of one or more hard constraints that are evaluated at the recipe level. At block 506, the selected recipe set is compared to or evaluated with respect to the first group of hard constraints at the recipe-set level.

In various embodiments, one or more pieces of information associated with each recipe or each item of each recipe of the selected recipe set is obtained, analyzed, and compared to the hard constraints. For example, the selected recipe set may be analyzed to ensure that the selected recipe set does not have a cost that exceeds a customer-selected maximum cost. Similarly, the selected recipe set may be analyzed to ensure that the total packaging volume of all the items for each recipe in the selected recipe set does not exceed a maximum packaging volume. As another example, the selected recipe set may be analyzed to ensure that the total number of items associated with the selected recipe set does not exceed a maximum number of items. These examples are for illustrative purposes and other hard constraints may be employed and evaluated on the selected recipe set.

Process 500 proceeds next to decision block 508, where a determination is made whether the selected recipe set violates at least one hard constraint. If the selected recipe set violates at least one hard constraint, then process 500 flows to block 516; otherwise, process 500 flows to block 510.

At block 510, each recipe associated with the selected recipe set is individually compared to the second group of hard constraints that are evaluated at the recipe level. In various embodiments, one or more pieces of information associated with each recipe or each item of each recipe of the selected recipe set is obtained, analyzed, and compared to the hard constraints. For example, each recipe in the recipe set may be analyzed to ensure that no recipe in the recipe set includes an item that is an allergen to the customer. Similarly, each recipe in the recipe set may be analyzed to ensure that no recipe includes an item that is restricted or prohibited by the customer. A restricted item may be an item that the customer really does not want (e.g., the customer hates the taste of tofu), whereas a prohibited item may be an item that the customer cannot consume (e.g., the customer is allergic to peanuts). These examples are for illustrative purposes and other hard constraints may be employed and evaluated on each recipe for the selected recipe set.

Process 500 continues as decision block 512, where a determination is made whether a recipe in the selected recipe set violates at least one hard constraint. If at least one recipe violates at least one hard constraint, then process 500 flows to block 516; otherwise, process 500 flows to decision block 514.

At block 516, the selected recipe set is determined to be in violation of at least one hard constraint and is therefore discarded from the sets of recipes that can be selected and provided to the customer. After block 516, process 500 flows to decision block 514.

At decision block 514, a determination is made whether another recipe set is selected from the plurality of sets of recipes. In some embodiments, each recipe set is selected and compared to the hard constraints. If another recipe set is to be selected, process 500 loops to block 504; otherwise, process 500 terminates or otherwise returns to a calling process to perform other actions. For example, process 500 can return to process 300 in FIG. 3 to select one of the remaining recipe sets to provide to the customer.

FIG. 6 illustrates a logical flow diagram showing one embodiment of an overview process 600 for generating a dynamic questionnaire for a customer and modifying future questions based on customer feedback in accordance with embodiments described herein.

Process 600 begins, after a start block, at block 602, where a plurality of questions are generated. In various embodiments, an administrator may input or define the plurality of questions with known answers. The answers may be true/false, or they may be exclusive and multi-optional (e.g., a or b or c or d, but not more than one), or they may be non-exclusive and multi-optional (e.g., a or b or c or d, or any combination thereof). In some embodiments, the known answers are selectable by the customer without enabling the customer to customize, define, or alter the answers (e.g., no customer input via a text box).

Process 600 proceeds next to block 604, where recipe attributes are assigned to each question and answer. Recipe attributes may be related to type of cuisine, spice preferences, dietary aspects, items or ingredients used in a recipe, item quantities needed for a recipe, number of steps in a recipe, preparation time for the recipe, cook time of the recipe, level of difficulty in making the recipe, etc. For example, a question may be “Do you like spicy foods?” with the possible answers of “Yes” and “No.” The “yes” answer of this question may be assigned the recipe attribute of “spicy” and the “no” answer may be assigned the recipe attribute “non-spicy.” As another example, a question may be “Do you like steak?” with the possible answers of “Yes” and “No.” The “yes” answer of this question may be assigned the recipe attributes of “steak” and “non-vegetarian” and “non-vegan” and the “no” answer may be assigned the recipe attribute “non-steak.” The same or different recipe attributes can be assigned to different questions and answers. According, the assignment or mapping of recipe attributes to questions and answers may be non-exclusive. In some embodiments, one or more recipe attributes may be exclusive to a particular question and answer.

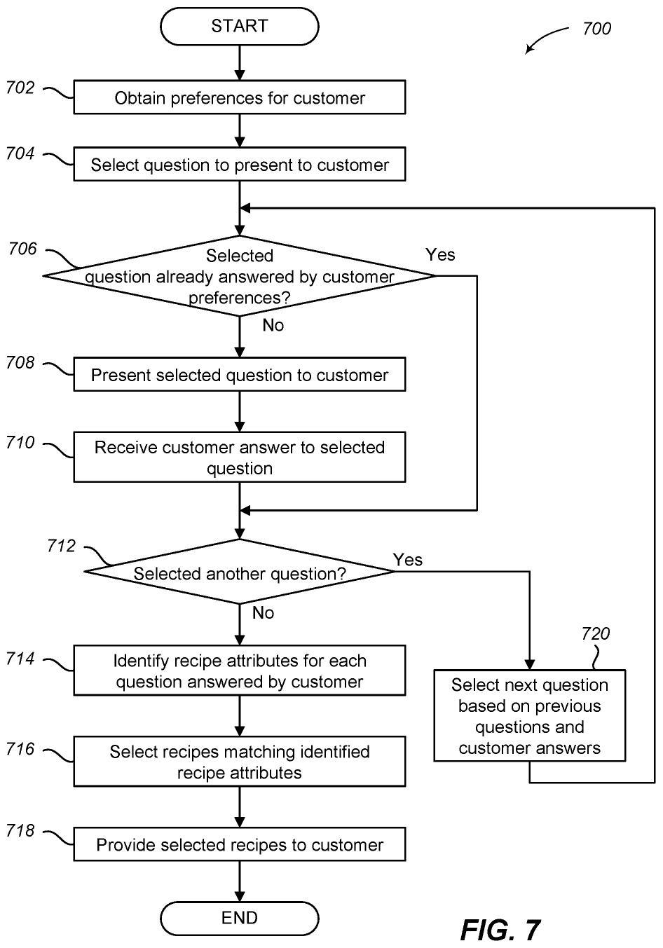

Process 600 continues at block 606, where a customer is asked questions and answers are obtained for each question, which is described in more detail below in conjunction with FIG. 7. Briefly, however, a dynamic-question-selection data structure is utilized such that a first question is selected and presented to the customer, a first answer is received from the customer, a second question is then selected based on the first answer and presented to the customer, a second answer is received from the customer. A third question is then selected based on the second answer and presented to the customer, and so on.

In some embodiments, separate dynamic-question-selection data structures may be generated and maintained for different geographic regions, for different customer demographics, for different customer dietary requirements or preferences, or for other groups of customers. In various embodiments, the dynamic-question-selection data structure that is associated with customer may be selected and used to selected question to present to the customer.

Process 600 proceeds next to block 608, where a group of initial recipes are selected for the customer, which is described in more detail below in conjunction with FIG. 7. Briefly, however, the initial recipes are selected based on the questions presented to the customer, and the answers received from the customer, and the recipe attributes assigned to those questions and answers. As discussed above, these initial recipes may be provided to the customer or they may be used to predict and optimize recipes for the customer.

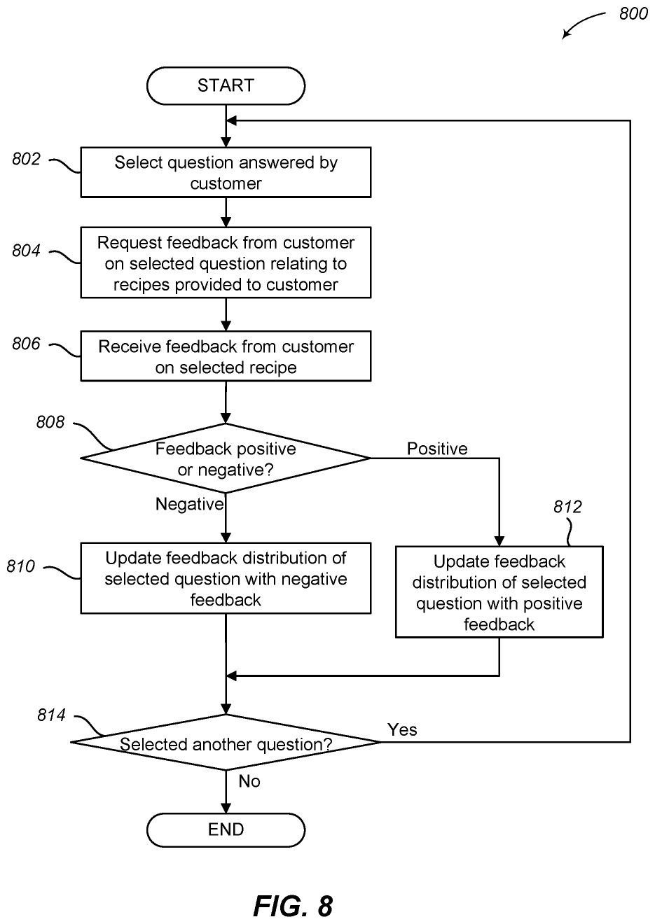

Process 600 continues next to block 610, where customer feedback is received on one or more of the selected recipes, which is described in more detail below in conjunction with FIG. 8.

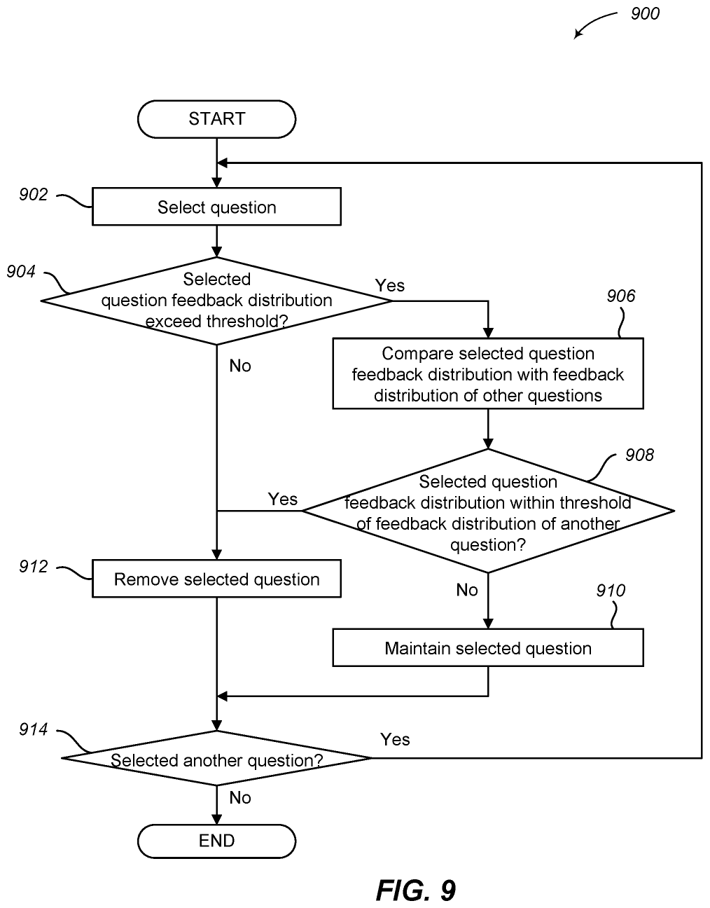

Process 600 proceeds to block 612, where one or more questions may be modified based on the customer feedback, which is described in more detail below in conjunction with FIG. 9. Briefly, however, the dynamic-question-selection data structure may be modified based on the customer feedback by removing questions or merging questions or adding new questions.

After block 612, process terminates or otherwise returns to a calling process to perform other actions. In various embodiments, process 600 may loop (not illustrated) to block 606 to present new or additional questions to the customer and to obtain new answers, which may be based on the feedback provided by the customer.

FIG. 7 illustrates a logical flow diagram showing one embodiment of a process 700 for selecting and presenting questions to a customer and selecting recipes based on those questions in accordance with embodiments described herein.

Process 700 begins, after a start block, at block 702, where preferences of the customer are obtained. In various embodiments, block 702 may employ embodiments of block 404 in FIG. 4 to obtain the customer's preferences.

Process 700 proceeds to block 704, where a question from a plurality of questions is selected to present to the customer. In some embodiments, this question may be a first question defined by the dynamic-question-selection data structure, such as a first question in a tree data structure (similar to what is shown in FIGS. 10 and 11). In some embodiments, a particular question within the dynamic-question-selection data structure may be selected as the initial question based on the customer's preferences. For example, if the customer preferences indicate that the customer is vegan, then the initially selected question may be the next question in the dynamic-question-selection data structure after a question asking if the customer is vegan.

Process 700 continues at decision block 706, where a decision is made whether the selected question has already been answered by the customer preferences. In various embodiments, this determination is made by comparing metadata or tags of the selected question to the customer's preferences. If a match is made, then the answer to the selected question is obtained based on the customer's preferences. For example, if the question is “Do you like jalapenos?” and the customer's preferences indicate that they do not like spicy food, then, in some embodiments, the answer of “no” may be presumed for the selected question from the customer preferences. In other embodiments, the selected question may be skipped based on the customer preferences. Conversely, if the customer's preferences indicate that they do like spicy food, then the answer is not necessarily “yes.” In this case, the selected question is not answered by the customer's preferences. In some embodiments, the question may have been previously answered by feedback provided by the customer.

If the selected question is answered by the customer preferences (or previously provided customer feedback), then process 700 flows to decision block 712; otherwise, process 700 flows to block 708.

At block 708, the selected question and its possible answers are presented to the customer. In various embodiments, the order-fulfillment server 102 sends a message to the customer device 120 of the customer to display the selected question and possible answers to the customer.

Process 700 proceeds next to block 710, where a customer answer to the selected question is received. In various embodiments, the order-fulfillment server 102 receives a message from the customer device 120 of the customer indicating the customer's answer. As discussed herein, this answer may be a single selection, such as true or false or option A, or it may be a multi-option selection, such as option A and option C.

Process 700 continues next at decision block 712, where a determination is made whether another question is selected. In various embodiments, the dynamic-question-selection data structure defines whether another question is to be selected based on the previously selected questions and the customer's answers. For example, if the dynamic-question-selection data structure is a tree structure, there may be additional questions in the current branch or path, or there may be a maximum number of levels to the tree, or there may be a defined number of levels for each separate branch. If there are additional questions in the current branch, as defined by the previously selected questions and customer answers, then another question is to be selected. If there are no additional questions in the current branch or path, then no additional questions are to be selected.

If another question is to be selected, process 700 flows to block 720; otherwise, process 700 flows to block 714.

At block 720, a next question is selected based on the previous question and the customer's answers. For example, if the dynamic-question-selection data structure is a tree structure, then a next question is selected as a next level or node in the tree based on the current node in the current branch or path and the previous customer answer. If the customer preferences answered the previous question, then that information is used to select the next question in the dynamic-question-selection data structure, without presenting the previously answered question to the customer.

After block 720, process 700 loops to decision block 706 to determine if the next question has been answered by the customer preferences. And if not, then the next question is presented to the customer at block 708.

If, at decision block 712, no additional questions are to be selected, process 700 flows from decision block 712 to block 714. At block 714, recipe attributes for each question and answer are identified. In various embodiments, a table or database may be maintained indicating the mapping or assignment of recipe attributes to questions and answers. If the dynamic-question-selection data structure is a tree structure, each node and edge in the tree may include one or more recipe attributes and as the tree is traversed for each selected question and answer, then those node and edge recipe attributes are identified. In other embodiments, each corresponding node in the tree structure may include its own recipe attributes and the recipe attributes of the previous questions and answers in that branch or path of the corresponding node.

Process 700 proceeds next to block 716, where one or more initial recipes are selected for the customer based on the recipe attributes identified for the selected questions and received answers. In some embodiments, the recipe attributes identified for the selected questions and received answers are compared to the recipe attributes of each of a plurality of recipes. Each recipe that includes a threshold number of the identified recipe attributes are selected as initial recipes. In some embodiments, this threshold may be 100 percent such that the initial recipes are those recipes that include all of the identified recipe attributes for the selected questions and received answers. In some embodiments, initial recipes may include additional recipe attributes that are not identified for the selected questions and received answers.

Process 700 continues next at block 718, where the selected initial recipes are provided to the customer. In some embodiments, the selected recipes may be provided directly to the customer. In other embodiments, the selected recipes may be further processed, such as described herein for predicting and optimizing recipes for the customer.

After block 718, process 700 may terminate or otherwise return to a calling process to perform other actions.

FIG. 8 illustrates a logical flow diagram showing one embodiment of a process 800 for processing customer feedback in accordance with embodiments described herein. In various embodiments, process 800 may execute after a customer has been provided at least one recipe, such as at block 718 in FIG. 7 or blocks 314 and 316 in FIG. 3.

Process 800 begins, after a start block, at block 802, where a question that was previously answered by the customer is selected.

Process 800 continues at block 804, where feedback on the selected question is requested from the customer. This feedback may be related to a specific recipe that was provided to the customer, or it may generally refer to multiple or all of the recipes provided to the customer. In various embodiments, this request is another question relating to the selected question. In this way, the feedback can be used to determine if the customer is or would have changed their previous answer to the selected question. For example, if the customer previously answered that they like spicy food, the feedback request may be “Was the recipe too spicy?” Depending on the customer's feedback, the answer to the previous question can be re-enforced or it can be changed to a different answer, or information or tags associated with the customer can be updated after factoring in prior answers and current answers.

Process 800 proceeds next to block 806, where feedback on the selected recipe is received from the customer. In some embodiments, this feedback may be in the form of positive or negative, such as “thumbs up” or “thumbs down.”

Process 800 continues next at decision block 808, where a determination is made whether the feedback was positive or negative. If the feedback was positive, then process 800 flows to block 812; otherwise, process 800 flows to block 810.

At block 812, the feedback distribution of the selected question is updated with the positive feedback. The feedback distribution may be the distribution of positive or negative feedback from a plurality of customers over time. In various embodiments, updating the selected question includes storing an indication with the selected question in the dynamic-question-selection data structure that the recipe provided to the customer was a positive experience. As discussed herein, the dynamic-question-selection data structure may be a tree structure. Because the same worded question can be asked along different branches or paths of the tree structure, the particular question in the particular branch or path that was previously answered by the customer in the dynamic-question-selection data structure is updated with the positive feedback. After block 812, process 800 flows to decision block 814.

If, at decision block 808, the customer feedback is negative, then process 800 flows from decision block 808 to block 810.

At block 810, the feedback distribution of the selected question is updated with the negative feedback. In various embodiments, this update includes storing an indication with the selected question in the dynamic-question-selection data structure that the recipe provided to the customer was a negative experience. Similar to block 812, the particular question previously answered by the customer in the dynamic-question-selection data structure is updated with the negative feedback. In some embodiments, the negative feedback may be stored as a customer preference such that a next time process 700 in FIG. 7 is executed for an order, the negative feedback is automatically used as an answer to that particular question. After block 810, process 800 flows to decision block 814.

At decision block 814, a determination is made whether another question that was answered by the customer is selected. In some embodiments, each question in the dynamic-question-selection data structure that was previously presented to and answered by the customer is systematically selected and processed for feedback. In other embodiments, a subset of those questions previously presented to the customer maybe selected. If another question is selected, process 800 loops to block 802 to select another question and obtain customer feedback; otherwise, process 800 terminates or otherwise returns to a calling process to perform other actions.

In various embodiments, process 700 in FIG. 7 may be executed again for a next customer order, which can account for the negative feedback as a customer preference or a previously answered question. For example, if a question received negative feedback, the system can automatically selecting another answer to that question for the customer, such as changing a previous answer of “false” to “true” or vice versa. The automatic changing of answers based on user feedback allows for the selection of different questions using the dynamic-question-selection data structure for future customer orders. In some embodiments, answers may not be automatically changed, but information or tags associated with the customer or the customer's preferences may be updated to indicate the negative feedback, which may be used to impact or alter future questions or future orders for the customer. In at least one embodiment, process 700 in FIG. 7 may be executed in response to negative feedback for the selected question, where the initial question selected at block 704 is a next question in the dynamic-question-selection data structure.

Moreover, although process 800 describes the customer feedback as positive or negative, embodiments are not so limited. In other embodiments, the customer feedback may be a rating or ranking system, such as 4.5 out of 5 stars. The rating can then be utilized to update the question and the question feedback distribution.

FIG. 9 illustrates a logical flow diagram showing one embodiment of a process 900 for utilizing customer feedback to modify future questions in accordance with embodiments described herein.

Process 900 begins, after a start block, at block 902, where a question in the dynamic-question-selection data structure is selected. In some embodiments, each question in the dynamic-question-selection data structure may be selected and processed.

Process 900 proceeds to decision block 904, where a determination is made whether the feedback distribution of the selected question exceeds a threshold. In some embodiments, the threshold may be a percentage, standard deviation, or some other statistical value indicating whether a question provides positive-experience recipes to customers or not.

Each question in the dynamic-question-selection data structure may include a feedback distribution indicating how successful that question is at providing positive-experience recipes to customers. As described herein, the dynamic-question-selection data structure may be a tree structure. Each node or question in the tree structure may include a feedback distribution. As a result, the feedback distribution of each question or node accounts for the combination of the other questions and answers in a same branch or path through the tree structure.

If the feedback distribution of the selected question exceeds the threshold, then process 900 flows to block 906; otherwise, process 900 flows to block 912.

At block 906, the feedback distribution of the selected question is compared to the feedback distribution of other questions in the dynamic-question-selection data structure. In some embodiments, all questions in the dynamic-question-selection data structure are compared to the selected question. In other embodiments, a sub-set of the questions in the dynamic-question-selection data structure are compared to the selected question. For example, in at least one embodiment, the comparison is between two questions that are the results of separate answers for a parent question. In at least one other embodiment, the comparison is made between two questions that are on a same branch or path of the dynamic-question-selection data structure.

Process 900 proceeds next to decision block 908, where a determination is made whether the feedback distribution of the selected question is within a comparative threshold of the feedback distribution of another question. This comparative threshold may be a percentage, standard deviation, or some other statistical value indicating whether both questions provide a same or similar positive experience to customers. This comparative threshold may be different from the threshold utilized in decision block 904. If the feedback distribution of the selected question is within the comparative threshold of the feedback distribution of another question, then those questions may not improve the positive experience of recipes provided to customers, and process 900 proceeds to block 912 to remove the selected question from the dynamic-question-selection data structure. Conversely, if the feedback distribution of the selected question is not within the comparative threshold of the feedback distribution of another question, then those questions may separate improve the positive experience of recipes provided to customers, and process 900 proceeds to block 910 to maintain the selected question.

After block 912 and 914, process 900 proceeds to decision block 914, where a determination is made whether another question in the dynamic-question-selection data structure. If another question is to be selected process 900 loops to block 902; otherwise, process 900 terminates or otherwise returns to a calling process to perform other actions.

FIGS. 10-11 illustrate use case examples of data structures for dynamically selecting questions for customers in accordance with embodiments described herein.

Dynamic-question-selection data structure 1000 in FIG. 10 is a tree structure with multiple questions 1002a-1002h illustrated as nodes and multiple answers 1004a-1004n illustrated as edges. Each question 1002 includes a plurality of answers 1004. For example, question 1002a has two possible answers 1004a and 1004b, question 1002b has three possible answers 1004c and 1004d and 1004e, question 1002c has two possible answers 1004f and 1004g, question 1002d has two possible answers 1004h and 1004i, question 1002f has three possible answers 1004j and 1004k and 1004l, and question 1002h has two possible answers 1004m and 1004n. Questions 1002e and 1002g also include answers, but those answers are not shown for simplicity.

In some embodiments, the same textual question may be included along different branches or paths of the dynamic-question-selection data structure 1000. For example, both question 1002d and question 1002h are illustrated as being “Question_4.” In this context, both questions may be the same, such as “Do you like rice?” Similarly, the same textual question may be at different levels of the dynamic-question-selection data structure 1000.

At the end of each branch or path of the dynamic-question-selection data structure 1000 is a set of food attributes 1006a-1006g. These food attributes 1006 account for the food attributes of each question and answer in that particular branch. For example, food attribute 1006c includes the food attributes assigned to question 1002a, answer 1004a, question 1002b, answer 1004e, question 1002f, and answer 1004j; whereas food attribute 1006g includes the food attributes assigned to question 1002a, answer 1004b, question 1002c, answer 1004g, question 1002h, and answer 1004n. Although FIG. 10 shows each branch or path of the dynamic-question-selection data structure 1000 as including a same number of question nodes or levels, embodiments are not so limited. In some embodiments, some of the branches or paths of the dynamic-question-selection data structure 1000 may have different numbers of questions along a given branch or path compared to another branch or path.

In this example, question 1002a is selected and presented to the customer. Assuming the customer responds with answer 1004a, then question 1002b is selected and presented to the customer. At this point, the customer has three answers to choose from. If the customer responds with answer 1004c, then question 1002d is selected and presented to the customer. Finally, assume the customer responds to question 1002d with answer 1004i. Following this path or branch of the dynamic-question-selection data structure 1000 results in food attribute 1006b.

As discussed herein, the dynamic-question-selection data structure 1100 may be generated by provided a variety of different known questions and answers to a plurality of test users. As these test users provide feedback, the feedback distribution of questions (or answers) can be modified such that one or more questions may be removed from the dynamic-question-selection data structure 1100, one or more questions may be added to the dynamic-question-selection data structure 1100, or a plurality of questions may be merged together in the dynamic-question-selection data structure 1100.

FIG. 11 illustrates another use case example of a data structure 1100 for dynamically selecting questions for customers in accordance with embodiments described herein. Dynamic-question-selection data structure 1100 is a tree structure with multiple questions 1102a-1102g illustrated as nodes and multiple answers 1004a-1004l illustrated as edges. Each question 1102 includes a plurality of answers 1104. In this example, question 1102a (“Do you like spicy food?”) has two possible answers 1104a (“Yes”) and 1104b (“No”). If the customer answers “No” to question 1102a, then question 1102c is selected and presented to the customer—the rest of this branch of the dynamic-question-selection data structure 1100 is not illustrated for clarity.

If the customer answers “Yes” to question 1102a, then question 1102b (Which cuisine do you prefer?) is selected and presented to the customer. From question 1102b, the customer can select one of three answers 1104c (“Thai”), 1104d (“Indian”), or 1104e (“Mexican”). If the customer answers “Indian” to question 1102b, then question 1102e is selected and presented to the customer—the rest of this branch of the dynamic-question-selection data structure 1100 is not illustrated for clarity.

But if the customer answers “Thai” to question 1102b, then question 1102d (“Do you like rice?”) is selected and presented to the customer. If the customer provides answer 1104f (“Yes”) to question 1102d, then attributes 1106a (spicy, Thai, rice) are used to select one or more initial recipes for the customer. Conversely, if the customer provides answer 1104g (“No”) to question 1102d, then attributes 1106b (spicy, Thai, non-rice) are used to select one or more initial recipes for the customer.

Moreover, if the customer answers question 1102b with “Mexican,” then question 1102f (“Which meat do you prefer?”) is selected and presented to the customer. If the customer provides answer 1104h (“Steak”) to question 1102f, then question 1102g (“Do you have a grill?”) is selected and presented to the customer. But if the customer provides answer 1104i (“Chicken”), then attributes 1106c (spicy, Mexican, Chicken) are used to select one or more initial recipes for the customer. Similarly, if the customer provides answer 1104j (“None”) to question 1102f, then attributes 1106d (spicy, Mexican, vegetarian) are used to select one or more initial recipes for the customer.

In response to question 1102g (“Do you have a grill?”), the customer can provide answer 1104k (“Yes”) or answer 1104l (“No”). If the customer provides answer question 1102g with “Yes,” then attributes 1106e (spicy, Mexican, Steak, grill) are used to select one or more initial recipes for the customer. But if the customer provides answer 1104l (“No”) to question 1102g, then attributes 1106f (spicy, Mexican, steak, stove/oven) are used to select one or more initial recipes for the customer.

After one or more of the initial recipes are provided to the customer, the customer is requested to provide feedback relative to those recipes. In some embodiments, the feedback request may directed to one or more of the questions presented to the customer and answered by the customer. For example, if food attributes 1106a are used to select the initial recipes for the customer, then the feedback request may be “Was the recipe good with the rice?” The feedback distribution for question 1102d is then updated based on the customer feedback. In other embodiments, the feedback request may be generic to the recipes provided to the customer. For example, if food attributes 1106a are used to select the initial recipes for the customer, then the feedback request may be “Was the recipe good?” In this case, the feedback distribution for question immediately preceding the food attribute 1106a (i.e., question 1102d) is updated based on the customer feedback.

In various embodiments, the feedback may be used to re-select questions for the customer. For example, if the customer indicates that they did not like any of the recipes selected using recipe attributes 1106a, then the system can provide a follow-up question related to another previous question answered by the customer. For example, question 1102b may be provided to the customer, but in this case, the answer 1104c (“Thai”) may be removed as an option. Therefore, in some embodiments, one or more answers of previous questions may change or be hidden in the dynamic-question-selection data structure 1100 or the answers provided to the customer may be modified to account for the customer's feedback. In other words, the dynamic-question-selection data structure 1100 may be re-employed using different questions or answering questions in the dynamic-question-selection data structure 1100 based on the customer's feedback to traverse a different branch or path of the dynamic-question-selection data structure 1100.

If, as feedback is received, modifies the feedback distribution of question 1102d to be similar (e.g., within an administrator-set threshold) to the feedback distribution of question 1102b, then question 1102d may be determined to be uninformative of what customers would prefer. In some embodiments, question 1102d could be removed from the dynamic-question-selection data structure 1100 such that answer 1104c of question 1102b would be to a combination of food attributes 1106a and 1106b (e.g., spicy, Thai). In other embodiments, another question may be added in response to answer 1104f, or answer 1104g, or both.

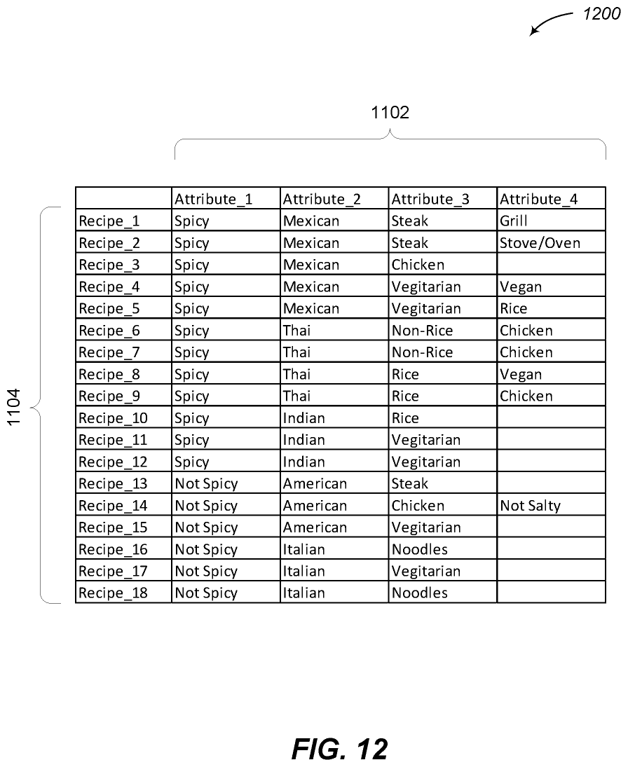

FIG. 12 illustrates a use case example of a data structure 1200 mapping recipes and attributes in accordance with embodiments described herein. In this illustrative example, data structure 1200 is a table that includes recipes 1104 and the mapped recipe attributes 1102. This data structure 1200 may be utilized to identify one or more initial recipes based on matching recipe attributes identified using a dynamic-question-selection data structure, as described herein.

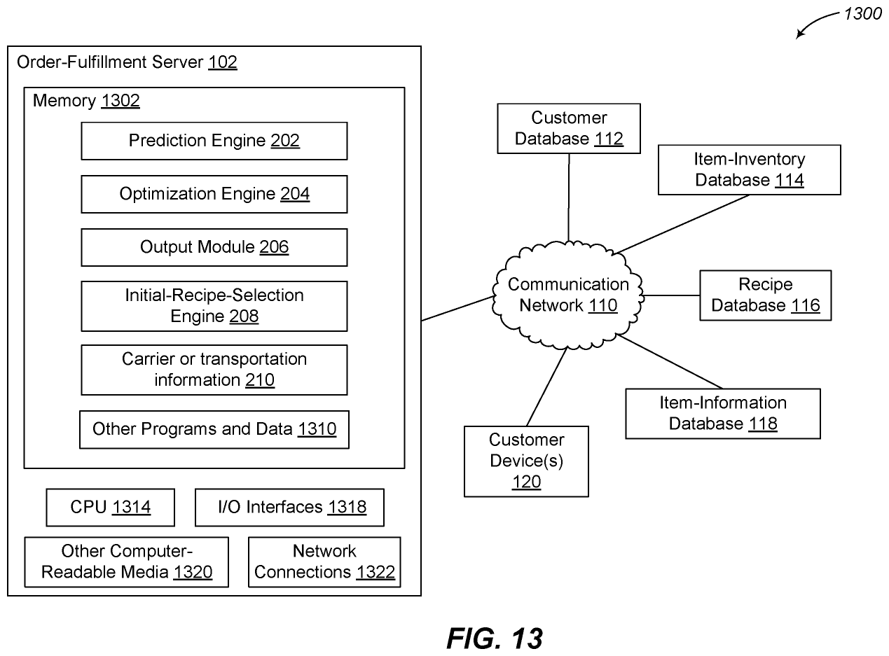

FIG. 13 shows a system diagram that describes various implementations of computing systems for implementing embodiments described herein. System 1300 includes an order-fulfillment server 102, customer database 112, item-inventory database 114, recipe database 116, item-information database 118, and customer devices 120, which may communicate with one another via network 110.

The order-fulfillment server 102 dynamically selects and presents questions to customers to select, generate, or identify a group of initial recipes for each separate customer, as described herein. In various embodiments, the order-fulfillment server 102 receives an order request for a customer from a customer device 120, predicts which of the group of initial recipes the customer will enjoy, optimizes those predicted recipes into a plurality of sets of recipes, and selects a set of recipes to provide to the customer, as described herein. One or more special-purpose computing systems may be used to implement the order-fulfillment server 102. Accordingly, various embodiments described herein may be implemented in software, hardware, firmware, or in some combination thereof. The order-fulfillment server 102 may include memory 1302, one or more central processing units (CPUs) 1314, I/O interfaces 1318, other computer-readable media 1320, and network connections 1322.

Memory 1302 may include one or more various types of non-volatile and/or volatile storage technologies. Examples of memory 1302 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. Memory 1302 may be utilized to store information, including computer-readable instructions that are utilized by CPU 1314 to perform actions, including embodiments described herein.

Memory 1302 may have stored thereon prediction engine 202, optimization engine 204, output module 206, and initial-recipe-selection engine 208. The initial-recipe-selection engine 208 is configured to dynamically select and provide questions to a customer based on the answers to those questions and to select initial recipes for the customer based on those questions and answers, as described herein. The prediction engine 202 is configured to utilize customer preferences and historical customer actions to predict which recipes the customer will enjoy, as described herein. The optimization engine 204 is configured to obtain the predicted recipes from the prediction engine 202 and generate a plurality of optimized sets of recipes, as described herein. The output module 206 is configured to select one of the optimized sets of recipes and initiate the fulfillment of the customer's order, as described herein. In various embodiments, the prediction engine 202, the optimization engine 204, the output module 206, and the initial-recipe-selection engine 208 may communicate with the customer database 112, the item-inventory database 114, the recipe database 116, or the item-information database 118 to obtain various information utilized in the prediction and optimization of recipes for a customer. Although the prediction engine 202, the optimization engine 204, the output module 206, and the initial-recipe-selection engine 208 are illustrated as separate components, embodiments are not so limited. Rather, one or more computing components or modules may be employed to perform the functionality of the prediction engine 202, the optimization engine 204, the output module 206, and the initial-recipe-selection engine 208.

Memory 1302 may also store carrier or transportation information 210 and other programs and data 1310. The carrier or transportation information 210 may include information or details regarding a current status of item carriers, previous transportation behavior or results of item carriers or order delivery transportation services, etc. Although the carrier or transportation information 210 is illustrated as being stored in memory 1302 of the order-fulfillment server 102, embodiments are not so limited. In some embodiments, the carrier or transportation information 210 may be stored by another database or computing device that is separate or remote from the order-fulfillment server 102. The other programs and data 1310 may include operating systems or other information. For example, in some embodiments, the data stored by the customer database 112, the item-inventory database 114, the recipe database 116, or the item-information database 118, or some combination thereof, may be stored in the memory 1302 of the order-fulfillment server 102.

In various embodiments, the network connections 1322 include transmitters and receivers (not illustrated) to send and receive data as described herein. I/O interfaces 1318 may include one or more data input or output interfaces that can be used to receive information from or display information to an administrator. For example, the I/O interfaces 1318 may include an input interface to receive hard constraints, soft constraints, or modifications thereof. Other computer-readable media 1320 may include other types of stationary or removable computer-readable media, such as removable flash drives, external hard drives, or the like.

The order-fulfillment server 102, the customer database 112, the item-inventory database 114, the recipe database 116, the item-information database 118, and the customer devices 120 are described in more detail above. The customer database 112, the item-inventory database 114, the recipe database 116, and the item-information database 118 utilize processors, memory, network connections, and other computing components similar to the order-fulfillment server 102. But those components are not illustrated in FIG. 13 to improve readability of the figure.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
receiving, by a computing device, a request for at least one recipe for a customer;
dynamically presenting, by the computing device, a plurality of questions to the customer, including:
selecting, by the computing device, a next question from a dynamic-question-selection data structure based on a previous question presented to the customer and a previous answer received from the customer;
presenting, by the computing device, the next question to the customer; and
receiving, by the computing device, a next answer to the next question from the customer;
identifying, by the computing device, a plurality of recipe attributes associated with the plurality of questions presented to the customer;
selecting, by the computing device, a group of initial recipes from a plurality of recipes for the customer based on the plurality of recipe attributes;
selecting, by the computing device, the at least one recipe from the group of initial recipes; and
providing, by the computing device, the at least one recipe to the customer.

2. The method of claim 1, wherein selecting the next question from the dynamic-question-selection data structure comprises:
determining, by the computing device, if the next question is answered by the preferences of the customer; and
in response to the preferences of the customer answering the next question, utilizing, by the computing device, the preferences to answer the next question without presenting the next question to the customer.

3. The method of claim 1, further comprising:
generating, by the computing device, the dynamic-question-selection data structure by:
presenting, by the computing device, a plurality of groups of questions to a plurality of training users;
receiving, by the computing device, answers from the plurality of training users;
presenting, by the computing device, a plurality of test recipes to the plurality of training users based on questions and answer received from the plurality of training users;
receiving, by the computing device, feedback from the plurality of training users; and
modifying, by the computing device, the plurality of groups of questions based on the feedback.

4. The method of claim 1, further comprising:
receiving, by the computing device, feedback from the customer; and
updating, by the computing device, the dynamic-question-selection data structure based on the feedback.

5. The method of claim 1, further comprising:
receiving, by the computing device, feedback from the customer; and
dynamically presenting, by the computing device, a new plurality of questions to the customer based on the feedback, including:
selecting, by the computing device, a new next question from the dynamic-question-selection data structure based on the feedback and a new previous question presented to the customer and a new previous answer received from the customer;
presenting, by the computing device, the new next question to the customer; and
receiving, by the computing device, a new next answer to the new next question from the customer.

6. The method of claim 5, further comprising:
identifying, by the computing device, a new plurality of recipe attributes associated with the new plurality of questions presented to the customer;
selecting, by the computing device, a new group of initial recipes from the plurality of recipes for the customer based on the new plurality of recipe attributes; and
providing, by the computing device, at least one new recipe from the new group of initial recipes to the customer.

7. The method of claim 1, wherein selecting the at least one recipe from the group of initial recipes comprises:
predicting, by the computing device, a plurality of recipes from the group of initial recipes for the order based on preferences of the customer and an order history of the customer;
generating, by the computing device, a plurality of sets of recipes from the plurality of predicted recipes based on at least one first constraint that constraints that cannot be violated by a recipe or set of recipes for the customer;
optimizing, by the computing device, the plurality of sets of recipes based on at least one second constraint that that expresses a tradeoff value associated with a recipe or set of recipes for the customer; and
selecting, by the computing device, the at least one recipe for the order based on the optimized plurality of sets of recipes

8. The method of claim 7, further comprising:
initiating, by the computing device, filling the request for the customer with items associated with the at least one recipe.

9. A non-transitory computer-readable medium storing computer instructions that, when executed by at least one processor, cause the at least one processor to perform actions, the actions comprising:
receiving an order request for at least one recipe for a customer;
dynamically presenting a plurality of questions to the customer, including:
selecting a next question from a dynamic-question-selection data structure based on a previous question presented to the customer and a previous answer received from the customer;
presenting the next question to the customer; and
receiving a next answer to the next question from the customer;
identifying a plurality of recipe attributes associated with the plurality of questions presented to the customer;
selecting a group of recipes from a plurality of recipes for the customer based on the plurality of recipe attributes; and
providing at least a portion of the a group of recipes to the customer.

10. The non-transitory computer-readable medium of claim 9, wherein selecting the next question from the dynamic-question-selection data structure comprises:
determining, by the computing device, if the next question is answered by the preferences of the customer; and
in response to the preferences of the customer answering the next question, utilizing, by the computing device, the preferences to answer the next question without presenting the next question to the customer.

11. The non-transitory computer-readable medium of claim 9, wherein the computer instructions, when executed by the at least one processor, further cause the at least one processor to perform further actions, the further actions comprising:
generating the dynamic-question-selection data structure by:
presenting a plurality of groups of questions to a plurality of training users;
receiving answers from the plurality of training users;
presenting a plurality of test recipes to the plurality of training users based on questions and answer received from the plurality of training users;
receiving feedback from the plurality of training users; and
modifying the plurality of groups of questions based on the feedback.

12. The non-transitory computer-readable medium of claim 9, wherein the computer instructions, when executed by the at least one processor, further cause the at least one processor to perform further actions, the further actions comprising:
receiving feedback from the customer; and
updating the dynamic-question-selection data structure based on the feedback.

13. The non-transitory computer-readable medium of claim 9, wherein the computer instructions, when executed by the at least one processor, further cause the at least one processor to perform further actions, the further actions comprising:
receiving feedback from the customer; and
dynamically presenting a new plurality of questions to the customer based on the feedback, including:
selecting a new next question from the dynamic-question-selection data structure based on the feedback and a new previous question presented to the customer and a new previous answer received from the customer;
presenting the new next question to the customer; and
receiving a new next answer to the new next question from the customer.

14. The non-transitory computer-readable medium of claim 13, wherein the computer instructions, when executed by the at least one processor, further cause the at least one processor to perform further actions, the further actions comprising:
identifying a new plurality of recipe attributes associated with the new plurality of questions presented to the customer;
selecting a new group of initial recipes from the plurality of recipes for the customer based on the new plurality of recipe attributes; and
providing at least one new recipe from the new group of initial recipes to the customer.

15. The non-transitory computer-readable medium of claim 9, wherein selecting the at least one recipe from the group of initial recipes comprises:
predicting a plurality of recipes from the group of initial recipes for the order based on preferences of the customer and an order history of the customer;
generating a plurality of sets of recipes from the plurality of predicted recipes based on at least one first constraint that constraints that cannot be violated by a recipe or set of recipes for the customer;
optimizing the plurality of sets of recipes based on at least one second constraint that that expresses a tradeoff value associated with a recipe or set of recipes for the customer; and
selecting the at least one recipe for the order based on the optimized plurality of sets of recipes

16. The non-transitory computer-readable medium of claim 15, wherein the computer instructions, when executed by the at least one processor, further cause the at least one processor to perform further actions, the further actions comprising:
initiating filling the request for the customer with items associated with the at least one recipe.

17. A computing system, comprising:
a recipe database that stores a plurality of recipes;
an item-inventory database that stores inventory information regarding a plurality of items associated with the plurality of recipes;
a customer database that stores preferences and order histories for a plurality of customers; and
an item-selection server that includes:
a memory that stores computer instructions; and
a processor that is configured to execute the computer instructions to:
receive a request for an order for a customer;
dynamically present a plurality of questions to the customer, including:
select a next question from a dynamic-question-selection data structure based on a previous question presented to the customer and a previous answer received from the customer;
present the next question to the customer; and
receive a next answer to the next question from the customer;
identify a plurality of recipe attributes associated with the plurality of questions presented to the customer;
select a group of initial recipes from the plurality of recipes for the customer based on the plurality of recipe attributes
obtain one or more hard constraints for the customer and the order, wherein the one or more hard constraints define at least one first parameter that cannot be violated by a recipe or set of recipes for the customer;
obtain one or more soft constraints for the order, wherein the one or more soft constraints define at least one second parameter that expresses a tradeoff value associated with a recipe or set of recipes for the customer;
select a plurality of predicted recipes from the group of initial recipes for the order based on preferences of the customer and an order history of the customer;
generate a plurality of sets of recipes from the plurality of predicted recipes based on the one or more hard constraints;
score each recipe set of the plurality of sets of recipes based on the one or more soft constraints, an inventory of items for the plurality of sets of recipes obtained from the item-inventory database, and the preferences of the customer obtained from the customer database;
select a set of recipes for the order based on the scores of the plurality of sets of recipes; and
initiate filling the order for the customer with items associated with the selected set of recipes.

18. The computing system of claim 17, wherein the processor of the item-selection server is configured to further execute the computer instructions to:
receive feedback from the customer; and
update the dynamic-question-selection data structure based on the feedback.

19. The computing system of claim 17, wherein the processor of the item-selection server is configured to further execute the computer instructions to:
receive feedback from the customer; and
in response to receiving another request for another order:
dynamically present a new plurality of questions to the customer based on the feedback, including:
select a new next question from the dynamic-question-selection data structure based on the feedback and a new previous question presented to the customer and a new previous answer received from the customer;
present the new next question to the customer; and
receive a new next answer to the new next question from the customer.
identify a new plurality of recipe attributes associated with the new plurality of questions presented to the customer; and
select a new group of initial recipes from the plurality of recipes for the customer based on the new plurality of recipe attributes.

20. The computing system of claim 19, wherein the processor of the item-selection server is configured to further execute the computer instructions to:
select a new plurality of predicted recipes from the new group of initial recipes for the other order based on the preferences of the customer and the order history of the customer;
generate a new plurality of sets of recipes from the new plurality of predicted recipes based on the one or more hard constraints;
score each recipe set of the new plurality of sets of recipes based on the one or more soft constraints, the inventory of items for the new plurality of sets of recipes obtained from the item-inventory database, and the preferences of the customer obtained from the customer database;
select a new set of recipes for the other order based on the new scores of the new plurality of sets of recipes; and
initiate filling the other order for the customer with items associated with the selected new set of recipes.
